(19) United States
(12) Patent Application Publication
(10) Pub. No.: US 2026/0021594 A1
(43) Pub. Date: Jan. 22, 2026

(54) Construction Robot with Changeover Interface, Parts System and Method For Arranging A Parts System On The Changeover Interface

(71) Applicant: Hilti Aktiengesellschaft, Schaan (LI)

(72) Inventors: Peter BRUGGER, Feldkirch (AT); Michael NITZSCHNER, Augsburg (DE); Rory BRITZ, Starnberg (DE); Florian HURKA, Margertshausen (DE); David WÖHRLE, Landsberg (DE); Markus HARTMANN, Mauerstetten (DE); Georg FÜRFANGER, München (DE); Tobias SCHMID, Emmenhausen (DE)

(21) Appl. No.: 18/997,261

(22) PCT Filed: Jul. 21, 2023
(86) PCT No.: PCT/EP2023/070302

§ 371 Date: Jan. 21, 2025

(30) Foreign Application Priority Data
Aug. 3, 2022 (EP) 22188419.0
Oct. 26, 2022 (EP) 22203863.0

(51) Int. Cl. B25J 15/04; B25J 11/00; B25J 15/00; B25J 19/00; B25J 19/02

(52) U.S. Cl. CPC B25J 15/0466; B25J 11/005; B25J 15/0019; B25J 19/0095; B25J 19/021

(57) ABSTRACT

A construction robot (10), in particular for performance of building construction work, including a manipulator (18), a changeover interface (21) arranged on the manipulator (18) and configured for releasable arrangement of at least one element, in particular a tool (24) and/or a component to be processed, on the manipulator (18). A test device (104) which is configured for quality testing of the changeover interface (21), safety risks on use of the construction robot (10) can be minimized.

The invention concerns a construction robot, in particular for performance of building construction work, comprising a manipulator and a changeover interface arranged on the manipulator and configured for releasable arrangement of at least one element, for example a tool and/or a component to be processed.

### BACKGROUND

In order to be able to perform complex construction tasks, often different tools are required. This is particularly the case when the construction tasks are to be performed using a construction robot. In order for example to arrange a construction element on a ceiling, firstly marks are made on the ceiling by means of a marking tool, showing where the construction element is to be arranged and/or where for example holes must be drilled for fastening elements for fastening the construction element. Then these holes can be drilled using a drilling tool. Then the necessary fastening elements can be fitted using a fitting tool. Finally, using a mounting tool, the construction element can be mounted on the fastening elements.

In order to be able to mount different elements, e.g. tools, on the construction robot and use these, the construction robot has a changeover interface. The changeover interface is configured for releasable arrangement of at least one element, e.g. the tools to be used. The elements to be mounted may have a connecting portion which is complementary to the changeover interface.

### SUMMARY OF THE INVENTION

Because of harsh environmental conditions on a construction site, in particular a building construction site, such changeover interfaces are often subject to heavy wear. Dust, dirt or similar can also hinder a correct mounting of the element on the changeover interface.

If an element is not properly mounted on the changeover interface, this constitutes a particular safety risk. Thus for example it is conceivable that the element will undesirably detach and cause damage when falling. In the worst case, injury can occur.

It is an object of the present invention to provide means and a method which allow safe use of different elements by a construction robot.

The present invention provides a construction robot, in particular for performance of building construction work, comprising a manipulator, a changeover interface arranged on the manipulator and configured for releasable arrangement of at least one element, in particular a tool and/or a component to be processed, and a test device which is configured for quality testing of the changeover interface.

The quality test may for example comprise a test for wear, function and/or incorrect seat of a tool arranged on the changeover interface.

Thus it is possible to monitor the changeover interface with respect to any safety risks before, during and/or after mounting and/or removal of an element, e.g. a tool, on or from the changeover interface.

This also allows continuous testing of the tool interface so that failures of the construction robot can be avoided and the construction robot can achieve a high system availability.

For example, before an element is mounted, the changeover interface may be checked for dust or dirt. If such a safety risk is found, for example a warning signal may be given, the safety risk may be eliminated, e.g. dirt removed, and/or other measures indicating and/or alleviating the safety risk can be taken.

A “tool” may also include electric machine tools such as e.g. machines for drilling, cutting—e.g. saws or angle grinders-grinding, marking, measuring or similar. Tools may be configured in particular for processing rock, for example concrete.

It is also conceivable that the changeover interface is configured so that other types of elements can also be mounted on the changeover interface. Thus for example it is conceivable that at least one component to be processed, e.g. a ceiling element, a wall element and/or an anchor, can be releasably arranged on the changeover interface.

The changeover interface is arranged on the manipulator. Depending on the element arranged on the changeover interface, different construction tasks can be performed at different positions and/or in different orientations by means of the manipulator.

It is particularly advantageous to use such a construction robot for performing construction work on building construction sites.

Whereas on excavation sites, it is possible to erect barrier zones which may not be accessed by persons during performance of construction work, this possibility often does not exist on building construction sites, or only to a very restricted extent. Also, on building construction sites, often a wider range of different elements, in particular tools, are used than on excavation sites. Often, elements must be changed more frequently. The probability of defective coupling of elements to the changeover interface, and hence the necessity of preventing such safety risks, may thus be higher on building construction sites than on excavation sites.

The construction robot may have at least one storage magazine which is configured to provide at least one element, in particular a tool and/or a component to be processed, for use by the construction robot.

Preferably, the storage magazine may be configured to provide the element for arrangement on the changeover interface. For this, the storage magazine may be arranged on the construction robot such that the changeover interface can be brought, in particular by means of the manipulator, up to an element held in the storage magazine. Preferably, the storage magazine may have several holding points. The holding points may then hold various tools needed for a construction task and/or other elements, in particular components to be processed. In particular after use of a tool, it is also conceivable that the tool no longer required is deposited in one of the holding points of the storage magazine and detached from the changeover interface.

The test device may comprise an optical test component. The optical test component may comprise an image capture unit, e.g. a color image camera, black/white camera and/or a 3D camera. The optical test component may be configured to detect optical data of the changeover interface. The optical test component may be arranged on the manipulator and/or on a mobile platform of the construction robot.

The test device may also comprise a light source. Thus recording conditions during capture of the optical data may be standardized. This may facilitate later analysis of the optical data. It is also conceivable that the light source is configured to project at least one pattern onto the changeover interface. Thus for example strip light images, from which depth information can be derived, may be captured.

It is also conceivable that a pre-existing image capture unit is also used as the optical test component. Thus for example it is conceivable that the construction robot already has an image capture unit on the manipulator. Such an image capture unit may then also serve as an optical test component of the test device. In this case in particular, it may be advantageous if a light deflection unit, e.g. a mirror, is arranged on the construction robot. The manipulator can then be brought into a position such that the image capture unit arranged thereon captures, via the mirror, the optical data of the changeover interface, which in particular is also arranged on the manipulator. Such multiple use of the same image capture unit may reduce the production costs of the construction robot. Also, the mass to be moved by the manipulator and hence the associated inertia can be kept low.

To analyze the optical data, the construction robot may have an image processing logic which is configured to receive optical data, in particular image data, from the optical test component and determine at least one quality feature of the changeover interface from the optical data. The quality feature may for example correspond to a sufficient absence of dust, dirt and/or wear phenomena, such as e.g. break points or abrasion points. In general, the quality feature may correspond to a sufficient conformity of the optical data with earlier and/or standardized optical data of the changeover interface. In other words, the quality features may be configured to indicate whether the changeover interface has any deviations from a nominal value within a defined framework. The quality feature may here relate to the total changeover interface or merely to a part region of the changeover interface.

It is also conceivable that the image processing logic is formed at least partly on a remote computer system, in particular a cloud-based computer system. Then by collecting optical data from multiple construction robots, analysis of the optical data can be continuously improved.

The construction robot may, alternatively or additionally, also be configured to determine at least one quality feature of the storage magazine. For this, the optical test component may also be configured to detect optical data of the storage magazine. Thus safety risks of the storage magazine due to dust, dirt, wear, elements incorrectly held in a holding point or similar, may also be detectable. Particularly preferably, it may be provided to use the same image capture unit as the test component.

It is also conceivable that the test device comprises a mechanical test component. This allows mechanical testing by use of a mechanical property of the tool interface, for example a force and/or a pressure, in particular a maximum holding force, a tensile stress and/or a contact pressure, an expansion, a distance or similar. Such a mechanical test may be carried out as an alternative or in addition to an optical test. Here it may be particularly advantageous that such a test using the mechanical test component can also test other safety risks than is possible with an optical test.

In particular, it is conceivable that the mechanical test component is configured to generate a mechanical resistance force so that an element held in the storage magazine can only be removed against the resistance force. The resistance force may correspond to a minimum necessary holding force. Preferably, the resistance force may exceed a weight force of the element held in the storage magazine.

When different types of elements are to be held in the storage magazine, the resistance force may be greater than the greatest weight force of all expected types of elements to be held. The resistance force may in particular be at least twice the weight force.

This may ensure that the element can only be removed from the storage magazine when the resistance force can be compensated or overcompensated. If removal takes place such that the element is coupled to the changeover interface and then the changeover interface is moved away from the storage magazine, e.g. by means of the manipulator, it can thus be ensured that the element is arranged on the changeover interface at least with a maximum holding force which corresponds at least to the resistance force.

Thus a sufficiently firm seat of the element on the changeover interface can be directly tested by means of the mechanical test component. The correct seat may in particular be ensured before the element, e.g. a tool, is used to perform a construction task.

The mechanical test component may be formed by a part of the storage magazine, a part of the manipulator and/or a part of the mobile platform.

The resistance force may be generated magnetically. For this purpose, the test component may have a magnet. For example, a magnet may be arranged at a holding point of the storage magazine. The element may have a magnetizable region. While the element is held in the holding point, the magnetizable region may thus be attracted by the magnet with a magnetic force corresponding to the resistance force. In order to remove the element from the holding point, the magnetic force and hence the resistance force, in some cases plus the weight force of the element, must then be overcome.

Alternatively or additionally, it is also conceivable that the test component has a latching mechanism. The latching mechanism may be configured so that latching is possible by application of the minimum release force. Then the minimum release force may form the above-mentioned resistance force.

Here it is also favorable that the mechanical test component requires no further electrical component, in particular no additional sensor, power supply or data lines for its supply. The changeover interface can particularly easily be automatically tested during, and in particular also by, the successful removal of the element.

Alternatively or additionally to at least one of the above-described test components, the test device may comprise an electrical test component. In particular, the electrical test component may be configured to detect an electrical quality feature of the changeover interface. If the changeover interface is configured for example for transmission of electrical energy and/or data, the electrical test component may be configured to test a current flow through electrical lines serving for transmission. An electrical resistance or similar may also be testable as a quality feature.

Such an electrical test can easily also be performed repeatedly. For example, such an electrical test can continuously monitor, in particular also during performance of a construction task, whether an element arranged on the changeover interface is correctly electrically connected to the changeover interface. This may then indicate whether the element as a whole is correctly seated on the changeover interface.

The invention furthermore concerns a parts system comprising an element, in particular a tool and/or a component, wherein the element has a connecting portion which is configured for releasable connection to the changeover interface of a construction robot of the above-described type. Such a parts system can be releasably arranged on the changeover interface, for example after testing of the changeover interface. Because of the testing possibility, safety risks, e.g. an accidental detachment of the element from the changeover interface, can be reduced or avoided.

The parts system and/or the construction robot may have a connecting portion test device which is configured for quality testing of the connecting portion. Preferably, the connecting portion test device comprises an optical, an electrical and/or a mechanical test component, in particular according to one of the above-described types.

The scope of the invention furthermore includes a construction robot comprising a parts system and a connecting portion test device which is configured for quality testing of the connecting portion.

By means of the connecting portion test device, a quality feature of the connecting portion can be tested. Depending on the quality feature determined, measures may be triggered as required. Here too, safety risks during use of the element on the construction robot can be reduced.

It is conceivable that the connecting portion test device is situated at least partly on the manipulator, on the mobile platform and/or on the storage magazine. The connecting portion test device may correspond to the test device, be at least a part of the test device, and/or also use a part of the test device.

The invention furthermore also concerns a method for arranging an element, in particular a tool and/or a component, on a changeover interface of a construction robot of the above-described type. The method comprises at least the steps:
a) testing of a quality property of the parts system and/or the changeover interface by means of a connecting portion test device and/or the test device, and
b) arranging the parts system on the changeover interface.

The quality feature may for example indicate an extent of wear, dirt, dust, and/or a presence or absence of an element.

The test may be carried out before, during and/or after arrangement. In particular, multiple tests are also conceivable. Depending on the result of the test, measures can then be taken. If for example an incorrect mounting of the element on the changeover interface is detected, the mounting attempts may be repeated as long as necessary for the element to be correctly mounted. Thus again safety risks can be reduced.

The method may provide that at least one test is performed using a mechanical test component and at least one test using an optical test component, so that different types of safety risk and/or similar safety risks can be identified with high probability and can then be alleviated. For example, firstly optically an extent of wear of the tool interface can be tested; then the seat of the element held on the tool interface can be mechanically tested.

It is also conceivable that a test is carried out by means of an optical test component, wherein the changeover interface is moved into at least two different positions relative to the optical test component. On subsequent analysis of captured optical data, this can facilitate a distinction between foreground and background data. In general, this may support the analysis of the optical data.

The method may also comprise that a quality feature of the storage magazine be for example an indicator of wear, abrasion and/or a presence or absence of a tool and/or component.

In particular, it is conceivable to provide that the changeover interface, a parts system and/or the storage magazine are tested using one and the same image capture unit.

The construction robot may be designed for performing construction work on a building construction site. It may be set up for performing construction work on a ceiling, a wall and/or a floor. It may be configured for marking, drilling, cutting, chiseling, grinding and/or fitting of a construction element: in particular corresponding tools may be releasably arrangeable thereon.

The construction robot has a manipulator. The construction robot may have a mobile platform. The manipulator may be arranged on the mobile platform.

The manipulator may be formed as a robot arm. The manipulator may also have a lifting device. The lifting device may increase the size of the overall volume that can be reached by the manipulator. The manipulator may have at least three degrees of freedom. In particular, it may have at least six degrees of freedom.

The mobile platform may comprise a wheeled undercarriage and/or a track-chain undercarriage. The mobile platform may have at least two degrees of freedom. The construction robot may have altogether at least ten degrees of freedom.

The image processing logic may be configured as a computer unit and/or may be part of a computer unit. The computer unit may have a processor, a memory unit and/or a program code that can be executed by the processor. The processor may have one or more sub-processors. The program code may be configured to implement the described method on the construction robot.

Further features and advantages of the invention are apparent from the detailed description of exemplary embodiments of the invention that follows, with reference to the figures of the drawing which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawing and elucidated in detail in the description that follows.

### BRIEF DESCRIPTION OF THE DRAWINGS

FIG. 1 shows a perspective view of a construction robot:

FIGS. 2 and 3 show side views of a manipulator with the changeover interface, by means of which a tool is to be removed from a storage magazine having a mechanical test component:

FIGS. 4 and 5 show top views of a connecting portion and a changeover interface which both show signs of wear:

FIGS. 6 and 7 each show a manipulator, a changeover interface, a storage magazine and a test device in perspective illustration; and

FIG. 8 shows a method.

### DETAILED DESCRIPTION

In the following description of the figures, comprehension of the invention is facilitated by use of the same reference signs in each case for identical or functionally corresponding elements.

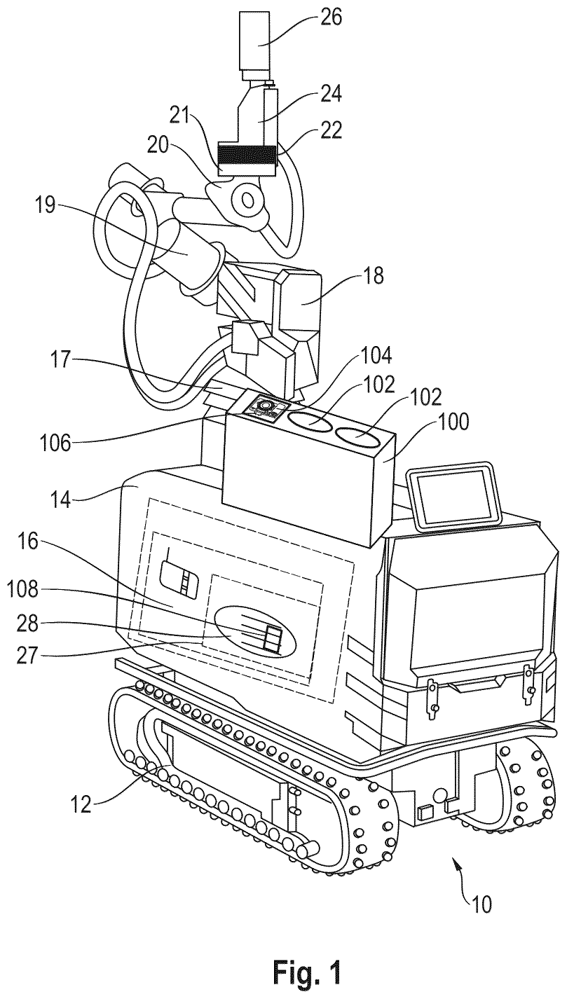

FIG. 1 shows a construction robot 10 with an undercarriage 12 designed as a track-chain undercarriage, a control space 16, formed in a housing 14, and a manipulator 18 arranged on top of the housing 14. The manipulator comprises a lifting device 17 for vertical displacement and a multiaxially controllable arm 19.

An end effector 20 with a changeover interface 21 is situated at the free end of the arm 19.

A tool 24, in particular a rock drill machine tool with a dust extraction device 26, is arranged on the changeover interface 21.

In order for the tool 24 to be releasably arranged on the changeover interface 21, it has a connecting portion 22. The changeover interface 21 is configured for releasable connection of the connecting portion 22 and hence also of the tool 24.

The manipulator 10 may comprise further devices, e.g. a prism, a paint spray device, a distance meter, a position and/or orientation determination logic, a camera and/or similar, although these are not shown in FIG. 1 for reasons of simplicity.

The construction robot 10 is designed for performing construction tasks, for example drilling work in ceilings and walls, on a construction site, in particular on a building construction site.

The construction robot 10 furthermore comprises a storage magazine 100. The storage magazine 100 has multiple deposit sites 102. Elements such as e.g. tools, for example the tool 24, and/or components required for construction tasks to be performed, may be deposited at the deposit sites 102.

In addition to the manipulator 18 for performing the construction tasks assigned to the construction robot 10, the construction robot 10 has a computer unit 27 arranged in the control space 16, in particular inside the housing 14. The computer unit 27 comprises a memory unit 28.

The computer unit 27 is equipped with executable program code. The program code may be stored in the memory unit 28 so as to be retrievable and executable. It may be configured to control the manipulator 18 so that one of the elements of the storage magazine 100 may in particular be removed from and/or deposited on one of the deposit sites 102 of the storage magazine 100.

Furthermore, the construction robot 10 has a test device 104, in particular on the storage magazine 100. The test device 104 is configured for quality testing of the changeover interface 21. For this purpose, it has an optical test component 106. The optical test component 106 comprises an image capture unit in the form of a color image camera. It may for example be oriented vertically upward so that it can capture images of the changeover interface 21 when the end effector 20 is brought into a position above the optical test component 106. An image processing logic 108, which is configured to compare one or more of the images with nominal depictions of the changeover interface and from this identify possible faults such as e.g. wear phenomena, dust or similar, is implemented in the computer unit 27, in particular by means of the program code. The image processing logic 108 is part of the test device 104.

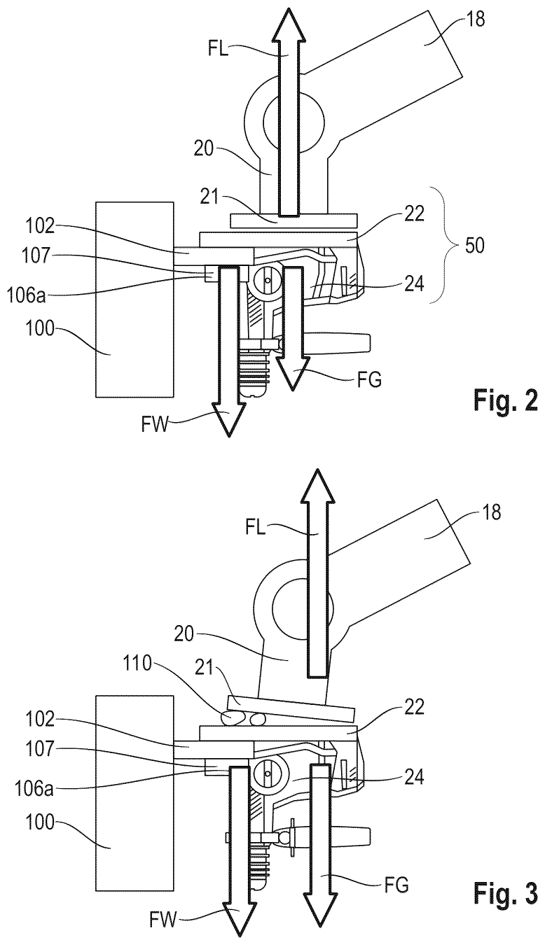

FIGS. 2 to 7 described below show components of alternative embodiments. Unless described otherwise, these components may be used on the above-described construction robot 10 as an alternative to the corresponding components thereof. In particular, it is conceivable to use different types of the alternative components described below in combination with a construction robot 10.

FIGS. 2 and 3 show schematically a storage magazine 100 with a deposit site 102.

An element, in particular a tool 24, is arranged at the deposit site 102.

The tool 24 has a connecting portion 22 for releasable connection to a changeover interface 21 arranged on an end effector 20 of a manipulator 18. The connecting portion 22 has a magnetizable plate, for example made of magnetizable steel.

The element, i.e. the tool 24, and the connecting portion 22 form a parts system 50.

A mechanical test component 106a is arranged on the storage magazine 100. The mechanical test component 106a has a magnet 107. The magnet 107 generates a resistance force FW, which is directed downward in the case illustrated in FIG. 2 and FIG. 3 and which supplements the weight force FG to retain the tool 24 in the deposit site 102. To pick up the tool 24, the manipulator 18 must therefore apply a release force FL which corresponds at least to the sum of the resistance force FW and the weight force FG, and is directed against the resultant of these two forces FW, FG. The changeover interface 21 is configured such that, when the element or tool 24 is correctly arranged on the changeover interface 21, at least the necessary release force can be transmitted so that when properly arranged, the tool can be successfully removed from the deposit site 102.

When the end effector 20 is moved vertically upward, wherein at least the release force FL is generated, the tool 24 or the parts system 50 can thus be removed from the deposit site 102.

FIG. 3 shows a situation corresponding to FIG. 2 but with the difference that the changeover interface 21 is soiled with dust 110. The tool 24 cannot therefore be properly connected to the changeover interface 21 via the connecting portion 22. In particular, the necessary release force FL can no longer be transmitted to the connecting portion 22 via the changeover interface 21.

When the end effector 20 is moved vertically upward, the connecting portion 22 detaches from the tool interface 21. The tool 24 or the parts system 50 cannot therefore be removed from the deposit site 102.

The tool 24 thus remains at the deposit site 102, whereby safety risks—e.g. by accidental detachment of the connecting portion 22 from the changeover interface 21 during performance of a construction task—can again be reduced or even avoided.

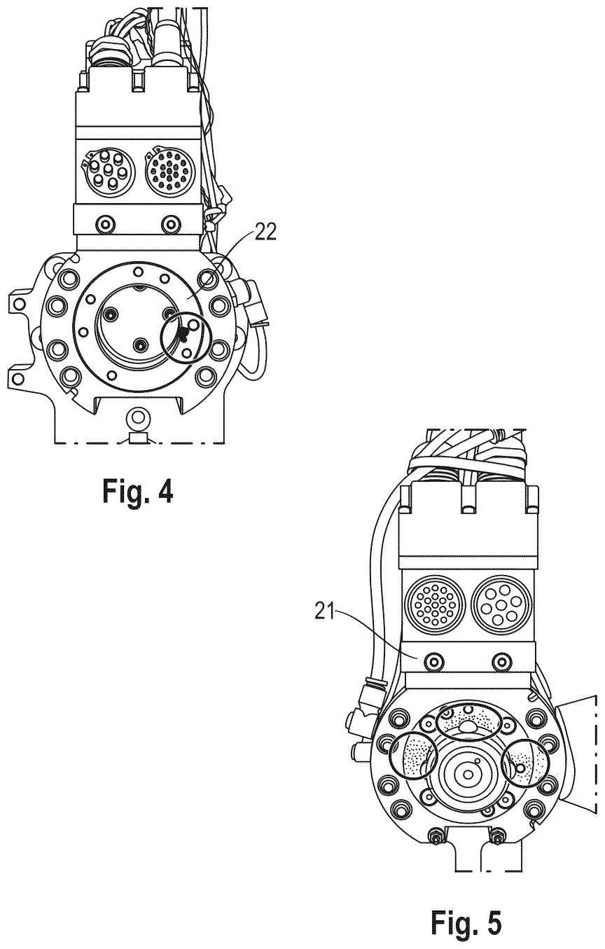

FIGS. 4 and 5 show top views of a connecting portion 22 (FIG. 4) and a changeover interface 21 (FIG. 5) which both show signs of wear. For clarification, the wear-affected points in FIG. 4 and FIG. 5 are highlighted with ellipses.

Such wear can be identified by means of optical test components, exemplary embodiments of which will be explained in more detail below.

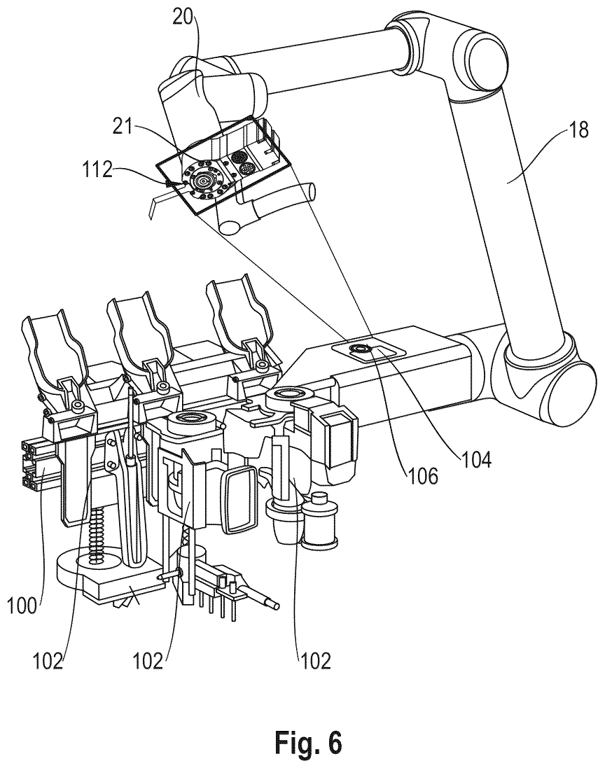

FIG. 6 shows a manipulator 18 with an end effector 20 on which, again, a changeover interface 21 is formed. A test device 104 is arranged on a storage magazine 100 with multiple deposit sites 102.

The test device 104 has an optical test component 106. The optical test component 106 comprises amongst others a color image camera.

FIG. 6 shows schematically a field of view 112 of the optical test component 106. In the position of the manipulator 18 shown in FIG. 6, the optical test component 106 may thus capture images of the changeover interface 21. These may be analyzed in an image processing logic of the test device 104, for example as described above, so that any safety risks can be identified.

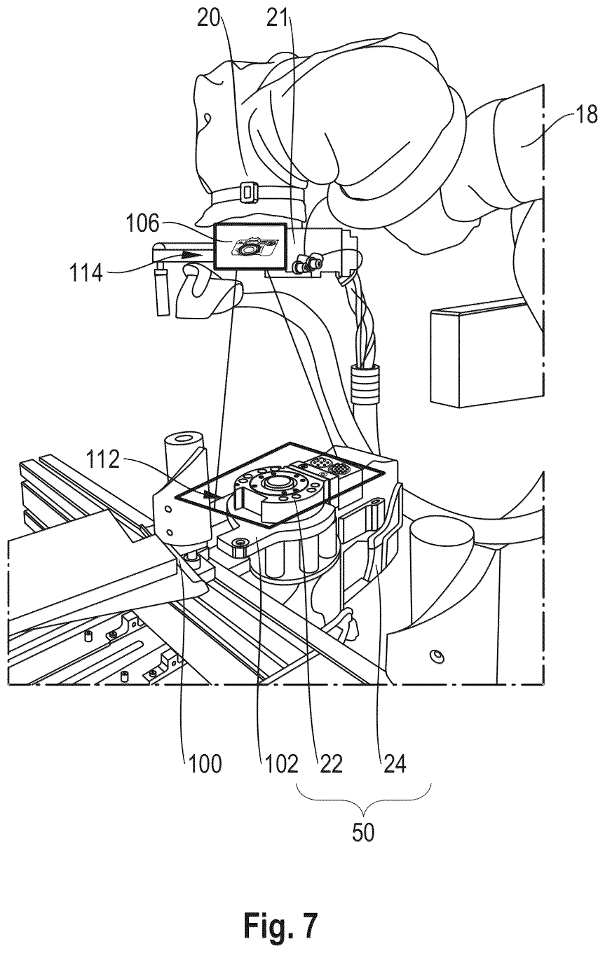

FIG. 7 shows a further manipulator 18 with an end effector 20 on which, as well as a changeover interface 21, a further optical test component 106 is arranged which may correspond to the above-described optical test component 106 according to FIG. 6.

The optical test component 106 comprises a color image camera.

In the position of the manipulator 18 shown in FIG. 7, the field of view 112 of the optical test component 106 contains a connecting portion 22 of a tool 24 situated at a deposit site 102.

A connecting portion test device 114 is formed by the optical test component 106 together with a computer unit 27 (see FIG. 1). For this, the computer unit 27 is configured to analyze images provided by the optical test component 106 with respect to deviations of the connecting portion 22 from a nominal connecting portion, and thereby identify any safety risks in the connection of the connecting portion 22 to the changeover interface 21.

The tool 24 and its connecting portion 22 in turn form a parts system 50.

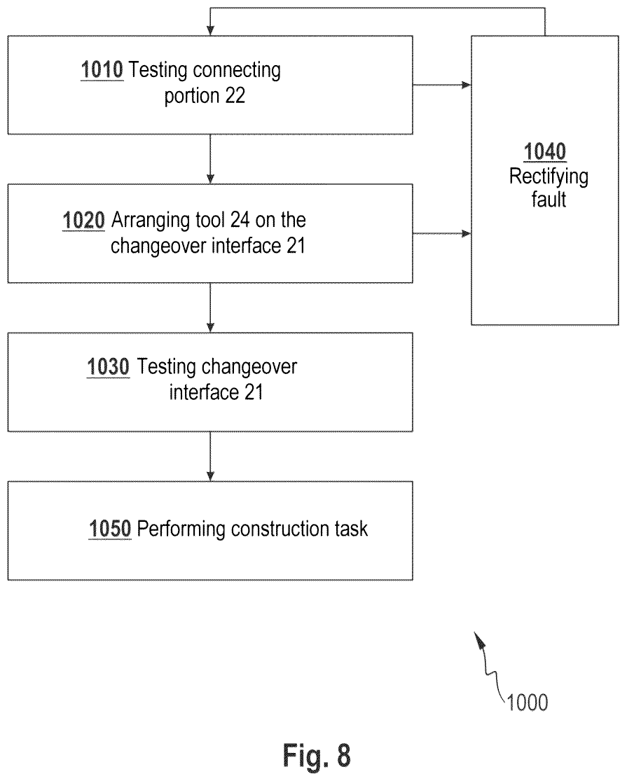

FIG. 8 shows a method 1000 for arranging a parts system on a changeover interface of a construction robot of the type described above.

The method 1000 is explained in more detail using the reference signs introduced above for components of the construction robot 10. For example, the construction robot 10 forming the basis of the description has a test device 102 with a mechanical test component 106a according to FIG. 2 and FIG. 3, and a connecting portion test device 114 with an optical test component 106 according to FIG. 7.

In a first method phase 1010, the connecting portion 22 of the tool 24, and hence also of the parts system 50, is tested for deviations from the nominal. In particular, the connecting portion 22 is tested for a quality property with respect to the presence of soiling, such as e.g. dust. In case of fault, a fault rectification 1040 takes place.

Firstly, in a coupling phase 1020, the changeover interface 21 is moved up to the connecting portion 22 of the parts system 50 by means of the manipulator 18. The changeover interface 21 is coupled to the connecting portion 22 and hence arranged on the parts system 50, in particular on the tool 24.

In a subsequent test phase 1030, it is tested whether the tool 24 is correctly coupled. For this, the manipulator 18 and hence the changeover interface 21 are moved away from the storage magazine 100. During this process, the release force FL is determined.

If the release force FL lies below a minimum release force to be expected depending on the resistance force FW and the type of tool, this indicates an incorrect coupling of the connecting portion 22 or tool 24 to the changeover interface 21. In this case too, a fault rectification 1040 takes place.

The fault rectification 1040 may consist of multiple steps. In particular, it may comprise a first fault treatment wherein, by means of a cleaning device e.g. a brush roller, firstly an attempt is made to clean the changeover interface 21 or connecting portion 22.

If a subsequent test again fails, a second fault treatment may be provided, during which an indicator signal is sent to a user of the construction robot 10 to rectify the fault manually.

It is conceivable, e.g. for documentation purposes, to store at least one of the results of the tests in the memory, and/or transmit this to a further computer unit, e.g. a cloud-based computer unit, for storage and/or further processing there.

It is also conceivable to carry out further tests. For example, an electrical test of an electrical resistance may be made in order to check whether one or more electrical connections between the changeover interface 21 and the connecting portion 22 have been properly created.

If the two tests in phases 1020, 1030 are successful, in a performance phase 1050, a desired construction task is performed with the tool 24 situated on the tool interface 20.

For example, one or more holes may be drilled with the tool 24 configured as a rock drill machine tool.

1-11. (canceled)

12. A construction robot comprising:
a manipulator;
a changeover interface arranged on the manipulator and configured for releasable arrangement of at least one element on the manipulator; and
a test device configured for quality testing of the changeover interface, or a connecting portion test device.

13. The construction robot as recited in claim 12 further comprising at least one storage magazine configured to provide the at least one element.

14. The construction robot as recited in claim 12 wherein the storage magazine is configured to provide the element for arrangement on the changeover interface.

15. The construction robot as recited in claim 12 wherein the test device is configured for the quality testing of the changeover interface and includes an optical test component.

16. The construction robot as recited in claim 15 further comprising an image processing logic configured to receive optical data from the optical test component and determine at least one quality feature of the changeover interface from the optical data.

17. The construction robot as recited in claim 16 wherein the optical data is image data.

18. The construction robot as recited in claim 12 wherein the test device is configured for the quality testing of the changeover interface and includes a mechanical test component.

19. The construction robot as recited in claim 12 wherein the mechanical test component is configured to generate a mechanical resistance force so that the element when held in the storage magazine is only removable against the resistance force.

20. The construction robot as recited in claim 12 wherein the robot a building construction robot.

21. The construction robot as recited in claim 12 wherein the element is a tool or a component to be processed.

22. The construction robot as recited in claim 12 wherein the test device is configured for the quality testing of the changeover interface and includes an electrical test component.

23. A parts system comprising:
an element having a connecting portion configured for releasable connection to the changeover interface of a construction robot as recited in claim 12.

24. The parts system as recited in claim 23 wherein the element is a tool or a component to be processed.

25. A method for arranging the parts system as recited in claim 23 to the changeover interface, method comprising at least the steps of:
a) testing of a quality property of the parts system or the changeover interface via the connecting portion test device or the test device; and
b) arranging the parts system on the changeover interface.

26. The method as recited in claim 25 wherein at least one test is carried out by a mechanical test component and at least one test is carried out by an optical test component.

27. The method as recited in claim 25 wherein a test is carried out by an optical test component, wherein the changeover interface is moved into at least two different positions relative to the optical test component.
